(19) United States
(12) Patent Application Publication
(10) Pub. No.: US 2026/0259936 A1
(43) Pub. Date: Sep. 3, 2026

(54) PROCESSING METHOD AND APPARATUS

(71) Applicant: Lenovo (Beijing) Limited, Beijing (CN)

(72) Inventors: Chen CHEN, Beijing (CN); Jiaqi WANG, Beijing (CN); Chun BI, Beijing (CN); Jiabin ZHANG, Beijing (CN)

(21) Appl. No.: 19/536,162

(22) Filed: Feb. 10, 2026

(30) Foreign Application Priority Data
Feb. 28, 2025 (CN) 202510241422.6

(51) Int. Cl. G06F 16/9035

(52) U.S. Cl. CPC G06F 16/9035

(57) ABSTRACT

A processing apparatus includes an action processing module, configured to obtain an action set formed by function units of at least one application on an electronic device, the action set representing actions that the electronic device is able to perform; and an intelligence processing module, configured to determine, in response to input data, a target action from the action set that corresponds to an intention represented by the input data through a target model, the intention being related to the target action.

### CROSS-REFERENCE TO RELATED APPLICATION(S)

This application claims priority to Chinese Patent Application No. 202510241422.6 filed on February 28, 2025, which is incorporated herein by reference in its entirety.

### FIELD OF THE TECHNOLOGY

The present disclosure relates to a field of artificial intelligence and device application technology, and more particularly to a processing method and apparatus.

### BACKGROUND

It has become common to use AI (Artificial Intelligence) on electronic devices such as PCs (Personal Computers) or mobile phones to assist users with their applications, thereby providing real-time, efficient intelligence services. Accordingly, how to provide users with real-time, efficient intelligent services based on AI to assist users in quickly performing relevant tasks has become a technical problem in this field.

### SUMMARY

In one aspect, the present disclosure provides a processing apparatus. The processing apparatus includes: an action processing module, configured to obtain an action set formed by function units of at least one application on an electronic device, the action set representing actions that the electronic device is able to perform; and an intelligence processing module, configured to, in response to input data, determine a target action from the action set that corresponds to an intention represented by the input data, through a target model; the intention being related to the target action.

In another aspect, the present disclosure provides a processing method. The processing method includes: obtaining input data; obtaining an action set based on the input data, the action set representing actions that an electronic device is able to perform; determining a target action based on the input data, the action set, and a target model; and outputting a response content to the input data, wherein the response content is related to the target action.

In yet another aspect, the present disclosure provides an electronic device. The device includes: a memory storing computer program instructions; and a processor coupled to the memory and configured to execute the computer program instructions and perform: obtaining input data; obtaining an action set based on the input data, the action set representing actions that the electronic device is able to perform; determining a target action based on the action set and a target model; and outputting a response content to the input data, wherein the response content is related to the target action.

### BRIEF DESCRIPTION OF THE DRAWINGS

To more clearly illustrate the technical solutions in certain embodiments of the present disclosure, the accompanying drawings for the description of certain embodiments are briefly introduced below. The drawings described below are merely examples of certain embodiments of the present disclosure, and those skilled in the technical field may obtain other drawings based on the provided drawings without inventive effort.

FIG. 1 is a schematic diagram of a processing apparatus provided in certain embodiments of the present disclosure;

FIG. 2 is a schematic diagram of an implementation architecture of a processing apparatus provided in certain embodiments of the present disclosure;

FIG. 3 is a schematic flowchart of a processing method provided in certain embodiments of the present disclosure;

FIG. 4 is a schematic diagram of a description and response content of the output target action provided in certain embodiments of the present disclosure;

FIG. 5 is a schematic flowchart of a processing method provided in certain embodiments of the present disclosure;

FIGS. 6(a) and 6(b) are schematic diagrams of alignment and display of corresponding target actions based on different screen interface information extracted, provided in certain embodiments of the present disclosure;

FIG. 7 is a schematic execution flowchart of a second mode provided in certain embodiments of the present disclosure;

FIGS. 8(a) and 8(b) are schematic diagrams illustrating how execution parameters are identified through conversation interaction for different target actions provided in certain embodiments of the present disclosure;

FIG. 9 is a schematic flowchart illustrating a second mode provided in certain embodiments of the present disclosure; and

FIG. 10 is a schematic block diagram of a structure of an electronic device provided in certain embodiments of the present disclosure.

### DETAILED DESCRIPTION

The technical solutions in certain embodiments of the present disclosure are described below with reference to the accompanying drawings. The described embodiments are only some embodiments of the present disclosure, not all of them. Based on certain embodiments of the present disclosure, other embodiments obtained by those skilled in the technical field without making inventive efforts shall fall within the scope of protection of the present disclosure.

The present disclosure in certain embodiments provides a processing method and apparatus for providing intelligence services to users in real time and efficiently based on AI, assisting users in quickly performing relevant applications. The provided processing method or apparatus may be applied to electronic devices in numerous general-purpose or specialized computing device environments or configurations, such as personal computers, server computers, handheld or portable devices, tablet devices, multi-processor devices, or the like.

The target model in certain embodiments of the present disclosure is a machine learning model that may recognize natural language and/or other inputs (such as audio, video, images, tables, or the like) input into the target model, and perform comprehensive language process tasks such as semantic analysis and question answering, thereby generating output related to the input and/or responding to the input. For example, the target model may be configured to evaluate semantic similarities between the input data and action attributes, or configured to operate on vectorized representations of the input data and the action set.

The target model involved in certain embodiments of the present disclosure learns the characteristics and patterns of natural language by training on a large amount of diverse data, thus enabling the model to understand and generate natural language. The target model typically has hundreds of millions to hundreds of billions of model parameters (model parameters are variables that control the behavior of the target model), capable of capturing complex relationships and patterns in natural language.

The target model involved in certain embodiments of the present disclosure may include one or more of a generative models or generative language models (GLMs). For example, the target model may include one or more of large language models (LLMs), GPT (Generative Pre-trained Transformer), or the like. The model involved in certain embodiments of the present disclosure example may include one or more of general-purpose large models, or expert large models obtained after fine-tuning based on specific needs. The present disclosure does not impose restrictions on the type of model used.

For example, an LLM may be a machine learning model, based on deep neural network architectures such as the transformer, that has been trained on large-scale corpora of natural language data. An LLM contains a very high number of parameters, e.g., in the order of billions or more, which enables LLM to capture statistical patterns, semantic relationships, and/or contextual dependencies in human language. The LLM can perform tasks including, but not limited to: natural language understanding (e.g., intent recognition, information extraction), natural language generation (e.g., text completion, summarization, dialogue response), reasoning and decision support, code generation, and multi-modal integration (in some cases). LLMs may operate by processing input sequences of tokens such as texts and predicting subsequent tokens in context, which allows them to generate coherent, contextually appropriate text. The large parameter size and training data scale distinguish LLMs from conventional language models, providing broader generalization and adaptability across domains without task-specific training.

In one embodiment, an LLM may be applied to establish the target model that is a machine learning model that may recognize natural language and/or other inputs (such as audio, video, images, tables, or the like) input into the target model, and perform comprehensive language process tasks such as semantic analysis and question answering, thereby generating output related to the input and/or responding to the input. For example, the target model may be configured to evaluate semantic similarities between the input data and action attributes, or configured to operate on vectorized representations of the input data and the action set.

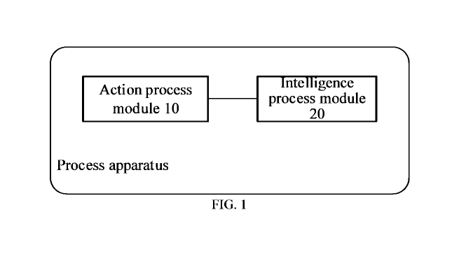

Referring to the structural diagram of the processing apparatus shown in FIG. 1, the processing apparatus provided in certain embodiments includes an action processing module 10 and an intelligence processing module 20.

The action processing module is used to obtain an action set formed by function units of at least one application on the electronic device, where the action set represents actions that the electronic device may perform.

The intelligence processing module is used to determine, in response to input data, a target action from the action set using a target model, where the target action corresponds to the intention represented by the input data; the intention being related to an action.

The action processing module may include an action acquisition module. The action processing module may collect actions supported by the function units of various applications, including built-in/proprietary applications (system applications) and third-party applications on the electronic device system, through the action acquisition module to form the action set.

The function units of an application support actions used to implement the functions corresponding to those function units. These actions may include, but are not limited to, scanning (such as QR code scanning), taking photos, navigation, location positioning, weather inquiry, and other actions corresponding to the different functions provided by different function units. A single function unit may support one or more actions, without limitation, depending on the number of functions the function unit may perform. For electronic devices, each action may be implemented through a series of actions (one or more actions). For example, the navigation action may be performed through a series of actions such as obtaining navigation parameters (source location, destination location), calling the navigation module, generating a path based on the navigation parameters, and displaying the path.

In certain embodiments, the processing method or processing apparatus provided in certain embodiments of the present disclosure may be implemented on an electronic device in the form of an application. For example, the method or apparatus provided in certain embodiments of the present disclosure may be implemented as a particular application such as an AI assistant (for example, Moto AI).

The action processing module may also collect actions supported by the operating system of the electronic device and/or the function units of the particular application (for example, Moto AI) used to implement the method or apparatus of the present disclosure. The particular application may also be considered a built-in/proprietary application of the electronic device system. The present disclosure does not impose restrictions on this.

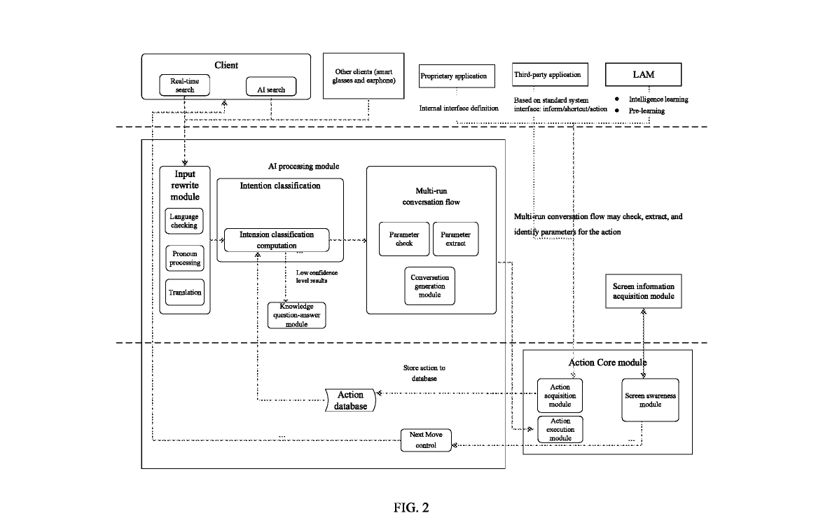

Reference may be made to FIG. 2 for an example architecture diagram of the processing apparatus. In certain embodiments, the action processing module and the intelligence processing module in the processing apparatus are implemented as the ActionCore module and the AI processing module shown in FIG. 2, respectively. As shown in FIG. 2, the ActionCore module includes an action acquisition module. The action acquisition module may obtain capability declaration information of various applications, such as the operating system and/or system applications and third-party applications of the electronic device, through corresponding interfaces, and collect actions supported by the function units of the operating system and/or various applications based on the capability declaration information. The present disclosure does not impose restrictions on this; in other embodiments, the action acquisition module may also interact with the operating system or various applications of the electronic device through a Large Action Model (LAM) to become aware of and collect actions supported by the function units of the operating system and/or various applications. LAMs build on the foundation of LLMs but add a crucial new capability — action. Instead of just producing responses, LAMs can understand intent, plan steps, and interact with tools or systems to carry out tasks.

Each action in the action set corresponds to multiple action attributes, including but not limited to the action name, action description, action execution parameter, and action example. The action execution parameter represents one or more parameters required to execute the action; the action description is used to explain and describe the action, primarily detailing the functions the action may perform; and the action example provides a particular demonstration of the action. In certain embodiments, attributes such as action descriptions and action examples may be provided in natural language form to target model such as large language model. This helps the target model enhance its understanding of the actions, enabling better execution of intelligence processing related to those actions, such as better aligning user-inputted intentions with corresponding actions.

The following provides an example of an action, using the "weather inquiry" action as an illustration. The examples of its various attributes are as follows:

Action name: Weather inquiry;

Action description: Inquires about the weather conditions at a particular location at a particular time;

Action example: Will it rain in Beijing this weekend?

Action execution parameters: Time parameter, location parameter.

The described action set may be implemented as, but is not limited to, an actions list. The following discussion uses an actions list as an example.

For the collected action set, such as an actions list, the present disclosure in certain embodiments vectorizes the action attributes (name, description, example, execution parameter, or the like) of each action and stores the resultant action attributes vectors, forming an action vectors library, or what may also be called an action database. This resultant action database is used to provide a basis for subsequent intelligence processing module to align the intention represented by the input data with the corresponding target action.

In certain embodiments, an Action Knowledge Base module (referred to as the Action KB module) may be set up in the intelligence processing module, such as the AI processing module shown in FIG. 2. This module is used at least to vectorize the action attributes of each action in the actions list and store the resulting vectors in a database to form the action database. The target model provided in certain embodiments may refer to the Action Knowledge Base module to provide aligning target actions or provide answers based on the matching target actions when responding to user input data.

In certain embodiments, the intelligence processing module may be used to obtain input data. In particular, the intelligence processing module may obtain, but is not limited to, at least one of the following 11)-13) as the input data:

11) Obtaining interaction attributes input through the interaction interface of the electronic device.

The interaction interface may be, but is not limited to, a text input interface or a voice interface provided by the electronic device, for example, text input controls or voice recording controls provided by a particular application on the electronic device, such as Moto AI, for interacting with the user to support user information/instruction input.

When users need to use particular applications such as Moto AI to assist in intelligence operations, they may input corresponding interaction attributes to the electronic device through the interaction interface according to their actual needs, such as inputting screen mirroring commands to Moto AI through the text input control to initiate screen mirroring.

12) Obtaining interface information obtained by performing information recognition and extraction on the screen interface of the electronic device.

The screen interface of the electronic device may be a function interface of the system functions used by the electronic device in actual applications or an application interface of the applications used, such as an instant messaging interface or an email application interface.

In certain embodiments, certain trigger conditions may activate an intelligence processing module to obtain and extract interface information from the screen of an electronic device. This information is then used to support subsequent processes based on a target model, which determines a target action from an action set that corresponds to the intention represented by the interface information, thereby assisting the user in quickly performing relevant tasks.

The trigger conditions may include, but are not limited to, the user having launched a particular application such as Moto AI or other AI assistants, and having activated a function or mode within that application to assist the user in performing actions, or the user temporarily instructing the particular application through commands (such as text or voice commands) to automatically and intelligently perform relevant actions.

In certain embodiments, as shown in FIG. 2, a screen awareness module may also be set up in the action processing module for screen interface information recognition and extraction. When the intelligence processing module, such as the AI processing module, needs to obtain the screen interface information of the electronic device, it may call this screen awareness module to recognize and extract information from the current screen interface of the electronic device, thereby supporting the intelligence processing module in obtaining the current screen interface information.

The screen awareness module may identify and extract information from the current screen interface through the accessibility services of the electronic device system, or it may use OCR (Optical Character Recognition) technology to identify and extract information from the current screen interface. However, it is not limited to these methods; it may also utilize the multimodal information recognition capabilities provided by multimodal large language models to identify and extract information from the current screen interface.

The identified and extracted screen interface information may include, but is not limited to, control information of the controls displayed on the current screen interface, the content of the interface, and/or user input information obtained through interaction with the user, depending on the actual content displayed on the current screen interface.

13) Obtaining image information acquired by the image acquisition apparatus.

When users need to use particular applications such as Moto AI to assist them with certain tasks, they may trigger the electronic device's image acquisition apparatus, such as the built-in camera or an external camera, through commands or other methods, to acquire relevant image information. This supports subsequent processes based on a target model to determine the target action that corresponds to the intention represented by the image information from a set of possible actions, thereby assisting the user in quickly performing the relevant application.

The acquired image information may include, but is not limited to, environmental images of the electronic device's surroundings or the display interface of another electronic device shown in front of the electronic device's image acquisition apparatus. For example, a computer camera may acquire an image of an item currently displayed on a user's mobile phone, or a mobile phone camera may acquire an image of an item in the surrounding environment. The subsequent target model may assist the user in quickly performing relevant actions by aligning the intention represented by the acquired information with a corresponding target action from an action set. For example, for an image of an acquired item, the target model may correspond to the target action "item purchase" from the actions list and present it to the user for selection, or directly jump to the purchase page of that item in a relevant e-commerce application, allowing the user to make a purchase.

The target model may include large model such as Large Language Models (LLMs) and/or pre-trained smaller model used for vector similarity (vector distance) measurement.

The intelligence processing module, in response to input data, determines a target action from the action set that corresponds to the intention represented by the input data using a target model. In particular, it may call corresponding smaller models for vector distance measurement and/or call larger models for aligning intention represented by the input data with a corresponding target action. For example, it may call the smaller model to perform vector distance calculations between the user's input instruction data (such as screen projecting commands entered through the natural language interface of Moto AI) and the vectors corresponding to each action in the actions list, thereby aligning one or more target actions with the intention represented by the user's input data through vector distance calculations. In certain embodiments, one may directly utilize the reasoning capabilities of a large language model to align the identified screen interface information and its represented intention with corresponding target actions from an actions list. One may also first use a smaller model to filter out the k candidate actions closest to the input data vector using vector distance measurement (for example, the top-k candidate actions), and then further use a large language model to determine the target action that corresponds to the input data from these top-k candidate actions. The present disclosure does not impose restrictions on this; the approach may be determined based on actual application requirements.

The number of target actions identified by the target model from the action set may be one or more, and the present disclosure does not impose restrictions on the number of target actions.

After identifying the target action that corresponds to the intention represented by the input data, the electronic device may display relevant information about the target action for the user to select and execute. This may include, but is not limited to, displaying interactive controls for the target action, such as a mail summary control for the "mail summary" target action, or a brightness adjustment control for brightness adjustment. The user may then decide whether to select/operate the displayed controls or other information to perform the corresponding target action(s) based on their actual needs.

In certain embodiments, the electronic device may also automatically perform the target action (such as executing a series of actions to achieve the target action) and display relevant response information. For example, the electronic device may automatically increase or decrease the brightness and display the response message "Brightness adjusted. Are you satisfied?" When the user is not satisfied with the result, corresponding controls may be displayed to allow the user to quickly perform the desired target action, such as displaying brightness adjustment controls for the user to quickly adjust the brightness, thereby assisting the user in quickly using the relevant application.

In certain embodiments, the processing apparatus provided in certain embodiments utilizes an action processing module to obtain an action set formed from the function units of at least one application on an electronic device, and uses an intelligence processing module to respond to input data. Through a target model, the processing apparatus determines the target action from the action set that corresponds to the intention represented by the input data. This allows for automatic and intelligent intention recognition of the input data and aligning it with the corresponding target action, thereby achieving real-time and efficient AI-based intelligent services for the user and assisting the user in quickly using relevant applications.

In certain embodiments, the action processing module in the processing apparatus may be used to perform the following: updating the action set in response to an update of an application on the electronic device and/or an update of a function unit of the application.

When an application on the electronic device, such as a third-party application or a system application, is updated, and/or a function unit of the application is updated, in response to the corresponding application/application function unit update event, the action processing module may call its action acquisition module to perform action acquisition at least for the updated application/application function unit (for example, acquiring the actions supported by the updated application/application function unit) to synchronously update the current actions list.

This includes, but is not limited to, installing new applications on the electronic device, uninstalling some of the installed applications, and/or updating the versions of some installed applications, fixing bugs/vulnerabilities, or the like.

When updating the current action set, such as the actions list, based on application update events, the following steps may be taken: add newly supported actions resultant from application installation events and/or version updates, bug fixes, or the like, to the current actions list; and reaction supported actions that are no longer available due to application uninstallation events and/or version updates, bug fixes, or the like, from the current actions list. And/or, for supported actions on electronic devices that change due to events such as application version updates or bug fixes, the corresponding action attributes in the current actions list may be modified. For example, when the "scan" action in a certain application, which is previously only used for scanning QR codes, may now also be used to scan barcodes and other electronic information codes after an application version update, then the "action description" and other attributes of the "scan" action in the actions list may be modified accordingly.

Updates to the application's function units may include, but are not limited to, application version updates, bug fixes, adding one or more function units to the application, removing one or more function units, or adjusting the functionality of one or more function units.

When updating the current action set, such as an actions list, based on function unit update events, the actions supported by the electronic device due to the addition of new application function units and/or function adjustments may be added to the current actions list; and the supported actions that are removed due to the removal of application function units and/or function adjustments may be removed from the actions from the current actions list, and/or, for supported actions on electronic devices that change due to function adjustments of application function units, the corresponding action attributes in the current actions list is modified accordingly. For example, the attributes for the "scan" action corresponding to the scan unit are modified as described above.

In certain embodiments, the operating system of an electronic device may be considered a type of program, possessing function units. Therefore, the action set may be synchronously updated based on update events of the operating system's function units. This allows for necessary additions, deletions, and modifications to the actions list to be made synchronously with updates to the electronic device's operating system, applications, and their included function units.

Certain embodiments update the action set in response to updates to applications on the electronic device and/or updates to the function units of the applications. This helps ensure that the series of actions and their associated attributes (such as name, description, action execution parameter, example, or the like) contained in the action set are consistent with the actions supported by the electronic device's operating system and application function units. This, in turn, helps guarantee the accuracy and effectiveness of the target actions aligned with the intention represented by the input data, using the action set as the alignment basis for the subsequent target model, thereby enabling accurate and efficient assistance to users in quickly performing relevant applications.

In certain embodiments of the present disclosure, the action set such as the actions list is independent of the target model. Updates to the action set are unrelated to the target model and do not require retraining or iterative updates of the target model. Therefore, updating the action set does not lead to burdensome model training or iterative update tasks, nor does it require target model training or optimization based on the user's individual circumstances. Since the action set is consistent with the operating system and applications on the user's personal electronic device, it may represent the user's individual circumstances. Thus, based on the action set, the present disclosure in certain embodiments uses the target model to align the corresponding target action with the intention represented by the input data. This allows for meeting the user's personalized needs without requiring targeted training of the target model based on the user's individual circumstances, avoiding burdensome model training or iterative update tasks, and enabling the provision of personalized intelligence services to the user in real time and efficiently based on AI.

In certain embodiments, the intelligence processing module in the processing apparatus is used to perform the steps 21)-23):

21) Processing the input data to determine the intention represented by the input data.

In certain embodiments, before determining the intention represented by the input data, the input data may first undergo input rewrite process, including but not limited to language checking, proper noun replacement, and translation.

The input data is rewritten to standardize and normalize the input data. Considering that the input data may be in various languages, but due to the limitations of the device's capabilities, the on-device model cannot support all languages. Therefore, language checking and translation functions are introduced during input rewrite to ensure that the input data is uniformly converted into a standardized language such as Chinese or English for subsequent processing. Proper noun replacement is used to ensure that some key nouns are not mistranslated; for example, "Super Connect" may be accurately replaced with "Smart Connect".

Referring to FIG. 2, in certain embodiments, an input rewrite module may be set up in an intelligence processing module, such as an AI processing module, to handle the aforementioned rewrite of the input data.

Based on this, the rewritten input data may be further processed to determine the intention represented by the input data.

In certain embodiments, the vector of the input data (for example, the rewritten input data) may first be compared with the vector of each action in the actions list for a measurement on vector similarity (vector distance). From this, the k action vectors closest to the input data vector (for example, the top-k action vectors with the smallest distance to the input data vector) are selected, and the corresponding actions and their similarity scores with the input data are determined.

The smaller the vector distance between the action vector and the input data vector, the higher the similarity score between the action and the input data; they are inversely related.

Subsequently, it may be further determined whether any action vector in the top_k action vectors has a corresponding similarity score exceeding a threshold (for example, 0.8). When such a vector exists, the input data may be considered a highly credible action execution command or contains a highly credible action execution command, thus determining that the intention represented by the input data includes the target intention. Otherwise, it may be determined that the intention represented by the input data does not include the target intention.

The target intention is related to an action, in particular an action-related intention, such as a photo-taking intention, a scanning intention, or other action-related intentions.

In certain embodiments, the small model described above for vector distance measurement may be called within the Action KB module to measure the vector distance between the input data vector and the action vector stored in the action database.

In certain embodiments, an intention recognition module may be further set up in the intelligence processing module. This intention recognition module achieves intention recognition by calling the Action KB module.

22) When the intention represented by the input data includes a target intention, triggering the process of determining a target action from the action set that corresponds to the intention represented by the input data, using the target model.

At this step, the target model may be a large language model or other large model.

When it is determined that the intention represented by the input data includes a target intention, this step may further involve calling a target model, such as a large language model, to align the input data with the top_k actions based on the model's reasoning capabilities. This process identifies one or more target actions from the top_k actions that correspond to the input data, and then uses these identified target actions to assist the user in relevant applications.

In certain embodiments, when one or more target actions aligning with the input data are identified from the top_k actions, it further indicates that the input data is a credible action execution command or contains a credible action execution command. Conversely, when no target action aligning with the input data is identified from the top_k actions, the intention of the input data may be corrected to indicate that it does not contain a target action.

23) When the intention represented by the input data does not include the target intention, the target model generates answer information corresponding to the intention represented by the input data.

When the intention represented by the input data does not include the target intention, then the intention represented by the input data is irrelevant to the action. In this scenario, the user's intention may be considered to be knowledge question-answer or question query (not including the target intention does not mean there are no other intentions). In this scenario, a large language model may be used to generate answer information corresponding to the intention represented by the input data, thereby assisting the user in relevant applications based on the generated answer information.

In certain embodiments, a knowledge question-answer module may be set up in the AI processing module, as shown in FIG. 2. This knowledge question-answer module generates answer information corresponding to the intention represented by the input data by calling target model such as large language model. The generated answer information may also be referred to as response information or response content.

In certain embodiments, it is also possible to directly use a large language model to align the input data with the action in the actions list without relying on methods such as vector distance measurement for intention recognition. For example, a large language model may be used to align the identified and extracted current screen information with a series of actions in the actions list to determine one or more target actions that correspond to the current screen information, thereby assisting the user in relevant applications. When no target action aligning with the current screen information is identified from the list of possible actions, it may be assumed that the user's intention does not include a target intention related to an action. In this scenario, the user's intention may be considered a knowledge question-answer or question query, and a corresponding answer may be generated. Alternatively, when the user's question is not clearly identified, an interactive interface may be provided to allow the user to submit their question, enabling the large language model to generate a corresponding answer.

Furthermore, regarding the scenario at step 22) where the intention represented by the input data includes a target intention, in addition to determining the target action that corresponds to the intention represented by the input data from the action set using the target model, it is also possible to generate corresponding answer information/response information. The generated answer information/response content is related to the target action. It is also possible not to generate corresponding answer information/response information; the present disclosure does not impose restrictions on this. Additional description may be found elsewhere in the present disclosure.

Through the above processing, certain embodiments may automatically and intelligently identify the intention of the input data and align the identified intention with the corresponding target action, or generate answer information, thereby achieving real-time and efficient AI-based targeted intelligence services for user intentions, assisting users in quickly using relevant applications.

In certain embodiments, after determining the target action that corresponds to the intention represented by the input data from the set of possible actions, the intelligence processing module in the processing apparatus may also perform the steps 31)-32):

31) Detecting whether the execution parameters required to perform the target action are currently missing.

In certain embodiments, after identifying one or more target actions that correspond to the intention represented by the input data, the system may automatically detect whether the execution parameters required for the target action are missing, either for a single target action or for the target action with the highest confidence level among multiple target actions (for example, the target action that best corresponds to the intention). Alternatively, the system may display the one or more target actions, and after the user selects a target action to execute, it may then detect whether the execution parameters required for that user-specified target action are missing.

This may be determined based on the execution parameters corresponding to the target action in the actions list. It involves detecting whether the input data (such as command information entered by the user through Moto AI's interactive controls) currently misses the execution parameters required to perform the target action. For example, when the user input is the command "Please check the weather," and the aligned target action is "weather inquiry," and assuming the execution parameters for weather inquiry in the actions list include location and time, then based on these execution parameters for the target action "weather inquiry," it may be detected that the "location" and "time" parameters required to perform this target action are currently missing. However, when the user input is the command "Please check the weather in xxx city at xxx time," then using the above method, it may be detected that the execution parameters required to perform the target action are not missing.

32) If so, the execution parameters required to perform the target action are identified through conversation interaction with the user of the electronic device.

In certain embodiments, when the execution parameters required to perform the target action are currently missing, the missing parameters may be obtained by engaging in a conversation interaction with the user of the electronic device.

This conversation interaction may be conducted through a particular application used to implement the method or apparatus of the present disclosure, such as Moto AI. The form of conversation interaction may include, but is not limited to, text-based or voice-based interaction using natural language. For example, the parameter inquiry statements may be output in the conversation interaction box of Moto AI to ask the user for the missing time and location parameters mentioned in the above example, thereby identifying the execution parameters required to perform the target action.

In certain embodiments, the action processing module in the processing apparatus may also be used to: execute the target action based on the execution parameters required to perform the target action.

The target action may include at least one executable action.

The action processing module may execute at least one executable action included in the target action on the electronic device, based on the corresponding execution parameters and in the execution order, to achieve the target action. Taking navigation as an example, the target action includes a series of executable actions such as calling the navigation module, using the navigation module to generate a navigation path based on navigation parameters (source location, destination location), and displaying the navigation path. Therefore, navigation may be achieved by sequentially executing these actions based on actual needs.

When the execution parameters required for performing the target action are not missing, the action processing module may directly execute the target action based on the corresponding execution parameters without performing the step of identifying the target action's execution parameters.

In certain embodiments, as shown in FIG. 2, an action execution module may be further set within the action processing module. This action execution module then executes the target action based on the corresponding execution parameters.

Certain embodiments help ensure an effective implementation of the target action by the action processing module by detecting whether the execution parameters required for executing the target action are missing and identifying them if necessary. This allows for real-time and efficient provision of intelligence services to users based on AI, assisting users in quickly utilizing relevant applications.

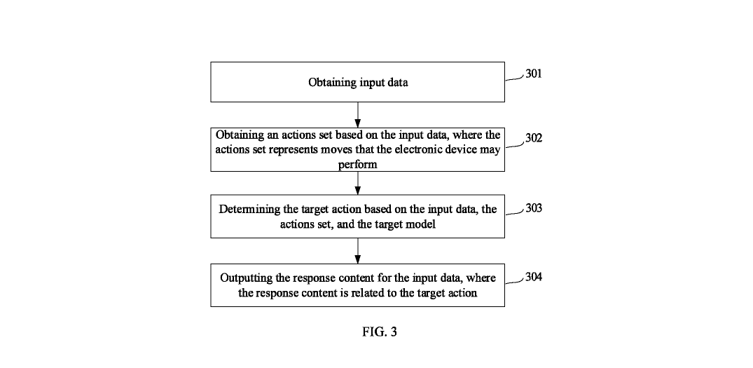

In certain embodiments, the processing method of certain embodiments of the present disclosure may be implemented based on the architecture provided by the processing apparatus described above. Referring to the flowchart of the processing method shown in FIG. 3, the processing method provided in certain embodiments of the present disclosure may include the steps 301 to 304, which are described in detail below.

Step 301: Obtaining input data.

The input data is the input data that represents the user's intention.

The intelligence processing module in the processing apparatus may obtain at least one of the following 11)-13) as the input data:

11) Obtaining interaction information input through the interaction interface of the electronic device;

12) Obtaining interface information obtained by performing information recognition and extraction on the screen interface of the electronic device;

13) Obtaining image information acquired by an image acquisition apparatus.

The more detailed process for obtaining the various input data at 11)-13) may be found in the relevant descriptions of the above embodiments, and will not be repeated here.

Step 302: Obtaining an action set based on the input data, where the action set represents actions that the electronic device may perform.

In response to receiving the input data, the intelligence processing module may obtain an action set based on the input data. More particularly, the intelligence processing module, such as the Action KB module in an AI processing module, may be called to obtain the action set. The acquisition of the action set at this step may involve obtaining the vectors corresponding to each action in the set, or it may involve obtaining non-vector attributes for each action in the set (such as action names, descriptions, execution parameters, and examples in natural language). The present disclosure does not impose restrictions on this; it may be determined based on actual application requirements.

Step 303: Determining the target action based on the input data, the action set, and the target model.

The target action corresponds to the intention represented by the input data.

After obtaining the input data and the action set, the intelligence processing module may determine, in response to the input data, the target action from the action set that corresponds to the intention represented by the input data, using the target model.

The intention is an intention related to the intention.

The number of target actions determined by the target model from the action set may be one or more, without limitation. The target actions include at least one executable action, where the at least one executable action is the next action that the electronic device may perform in response to the input data.

Step 304: Outputting the response content for the input data, where the response content is related to the target action.

The described response content is related to the described target action, and includes one of the options 41)-43):

41) Executing the target action while simultaneously outputting a response content to the input data.

At implementation 41), the target action is executed after it has been determined. The determined target action may be executed directly when only one target action is determined, or the target action with the highest confidence level among multiple determined target actions may be executed. Simultaneously, a response content to the input data is also output.

The response content may be the result of executing the target action. For example, when the target action is to adjust the brightness of an electronic device, the execution result may be increasing or decreasing the brightness. While adjusting the brightness, the system may output the brightness adjustment result, such as "Brightness has been increased or decreased," as the response information.

However, it is not limited to this. The response information may also be the executed target action itself. For example, in the above example, while adjusting the brightness, the system may output "Brightness adjustment has been performed. Are you satisfied?" to inform the user of the executed target action.

In certain embodiments, when user feedback indicates dissatisfaction, corresponding controls may be displayed to support users in quickly performing the desired target action, such as displaying brightness adjustment controls for users to quickly adjust brightness, thereby assisting users in quickly using the relevant application.

42) Obtaining interaction controls based on the target action, and outputting the response content of the input data based on the interaction controls for the target action.

Where, the response content includes the interaction controls for the target action.

Based on the interactive controls obtained for the described target action, which are the interactive controls for the target action, the user may trigger the corresponding target action by operating the interactive controls for the target action, such as clicking on them.

In certain embodiments, the interactive controls for the target action are obtained and may be output as the response content to the input data.

When there are multiple target actions, the interactive controls corresponding to each target action may be obtained, and the interactive controls for each target action may be output as the response to the input data. Users may select the desired interactive control from the output controls to trigger the corresponding target action, based on their actual needs.

43) Outputting the description of the target action; outputting the response content.

In certain embodiments, after determining the target action, the system outputs a description of the target action and simultaneously processes the input data as a user query to generate a corresponding response content (answer information). The target action and the response content are then summarized and output together, providing both a description of the target action and the response information corresponding to the input data.

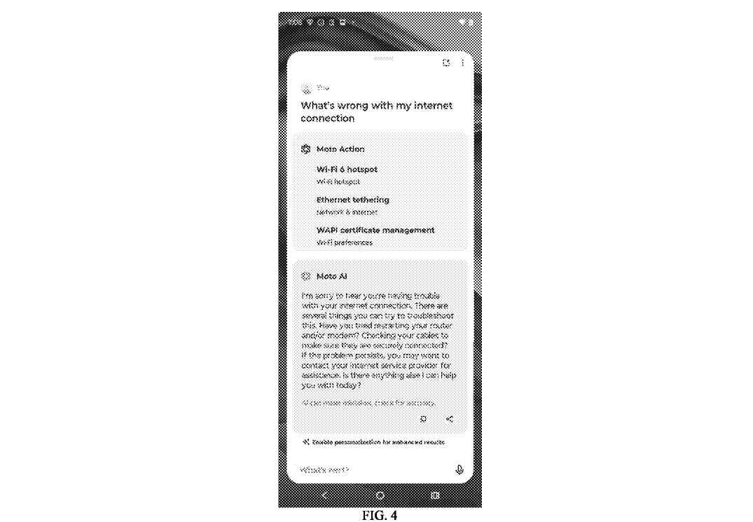

For example, suppose the input data is "What's wrong with my internet connection?" Based on this implementation, k target actions aligning with the intention represented by the input data may be identified from the actions list. Simultaneously, corresponding answer information/response content is generated for the input data. The k target actions and the response content are then summarized and output to the user to assist them in performing relevant actions to resolve their internet connection problem. FIG. 4 shows an example of the output of the target action descriptions and the response content for the aforementioned input data.

In certain embodiments, the processing method provided in certain embodiments obtains input data, derives an action set based on the input data, determines a target action based on the input data, the action set, and a target model, and outputs a response content corresponding to the input data. This method may automatically and intelligently process the input data, align it with the corresponding target action, and output the response content for the input data, thereby achieving real-time and efficient AI-based intelligent services for users and assisting them quickly using relevant applications.

In certain embodiments, the processing method provided in the present disclosure may also include:

Processing the input data to determine the intention represented by the input data;

When the intention represented by the input data includes a target intent, triggering the process of determining a target action corresponding to the input data from the action set using a target model, where the target intention is related to the action;

When the intention represented by the input data does not include the target intention, generating answer information corresponding to the intention represented by the input data using the target model.

The intelligence processing module in the processing apparatus may execute the various processing steps described in certain embodiments, such as determining the intention, aligning the intention with a target action, or generating answer information. A more detailed implementation process of the intelligence processing module executing these processing steps may be found in the description of the corresponding embodiments herein above, and is not repeated here.

In certain embodiments, by executing the above-mentioned processing steps of determining the intention, aligning the intention with a target action, or generating answer information in the intelligence processing module, the system may automatically and intelligently perform intention recognition on the input data and align the recognized intention with a corresponding target action or generate answer information. This achieves real-time, efficient, and targeted intelligence services for user intention based on AI, assisting users in quickly using relevant applications.

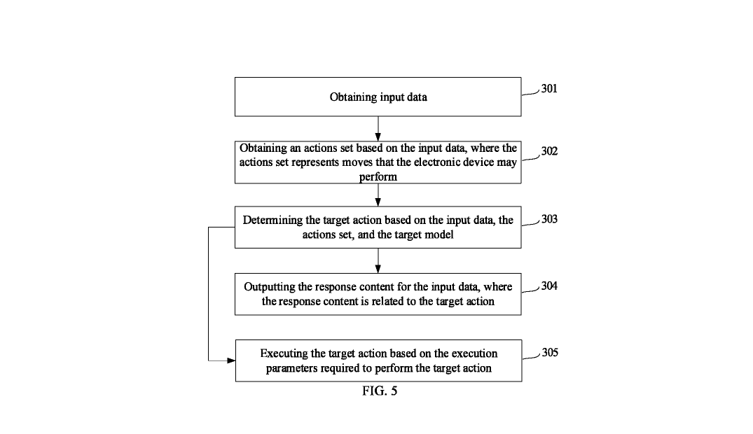

In certain embodiments, referring to the method flowchart shown in FIG. 5, the processing method provided in the present disclosure, after determining the target action based on the input data, the action set, and the target model, may further include:

Step 305: Executing the target action based on the execution parameters required to perform the target action.

The action execution module within the action processing module may execute the target action based on the execution parameters required to perform the target action. For example, it may execute a single target action determined based on the corresponding execution parameters, or execute the target action with the highest confidence level among multiple determined target actions.

Before executing the target action, the intelligence processing module may first detect whether the execution parameters required to perform the target action are missing; if so, it may identify the missing execution parameters by interacting with the user of the electronic device through conversation interaction.

The process of detecting whether execution parameters are missing and the process of identifying missing parameters by the intelligence processing module may be found in the description of the corresponding embodiments above, and is not repeated here.

Certain embodiments, by executing the target action based on the corresponding execution parameters after determining the target action, may assist users in automatically performing the required actions. Furthermore, by detecting whether the execution parameters required for performing the target action are missing before executing the target action, and identifying the missing parameters through conversation interaction with the user, it helps ensure the correct and effective implementation of the target action based on the identified execution parameters, thereby improving the accuracy and effectiveness of AI-based intelligence services provided to users.

The following provides an example of an implementation of the processing method or processing apparatus disclosed in the present disclosure.

In this example, two application modes, a first mode and a second mode, are provided on a particular application used to implement the processing method or processing apparatus of the present disclosure, such as an AI assistant like Moto AI.

### These two application modes are described below.

### First mode:

Also known as the Next Move mode, this mode's functions include: identifying and extracting content from the current screen interface of the electronic device, and submitting the extracted screen interface information and the device's capabilities (such as actions list) to an AI system for computation. The results of the computation are used to predict user behavior and are presented to the user.

### Second mode:

Also known as the "Find, do, ask anything" mode, this mode's functionality includes: the user inputs a command, the system corresponds the user's command with its capabilities (such as an actions list), the AI system performs computations and makes decisions to determine whether the user intends to perform an action or ask a question. If the user's intention is to perform an action, the system further checks and extracts parameters based on the action's information (such as the parameters required for executing the action). If necessary, it may interact with the user through conversation to identify the required execution parameters. Finally, it executes the action based on the execution parameters or generates an answer to the user's question.

In this example, as shown in FIG. 2, the ActionCore module is used to dynamically collect the actions supported by the operating system and application function units of the electronic device to form an actions list. This actions list is then synchronously updated (added, deleted, or modified) based on updates to the operating system/application or its function units. The action attributes in the actions list include, but is not limited to, the action name, action description, action example, and execution parameters required for action execution.

Furthermore, to address the issue that the client may not have the necessary permissions and capabilities to execute the actions, the ActionCore module also supports dynamic execution proxying for Action.

The dynamic execution proxying for Actions has system-level privileges, which are higher than client privileges. In situations where a particular application, such as Moto AI, lacks certain Action execution permissions and capabilities—for example, lacking permission to access user privacy-related functions such as the device's camera or location module—the required Actions may be executed through the Action's dynamic execution proxying. In certain embodiments, to protect user privacy, when calling the dynamic execution proxying of an Action, the user may be prompted for authorization. Only after obtaining user authorization will the dynamic execution proxying of the Action execute one or more required actions, such as taking a picture with the camera or using the location module for positioning. This approach, using the dynamic execution proxying, avoids frequently requesting user permissions every time high-privilege actions like taking a picture with the camera are performed.

In this example, the Screen Awareness module supports the extraction and recognition of the content on the user's current screen. The Action KB module then vectorizes and stores the actions dynamically collected by the ActionCore module, forming an action database.

Based on this, the system may support users in using the aforementioned particular applications, such as Moto AI, in either the first or second mode, providing corresponding intelligence services to assist users in quickly performing relevant tasks.

The exemplary implementation process of the first mode's functionality, namely the Next Action function, includes:

(a1) Calling the Screen Awareness module to extract and identify the content of the user's current screen. The Screen Awareness module may, but is not limited to, identify and extract screen interface content by using the system's accessibility services, OCR recognition technology, and/or multimodal large language models.

(a2) Calling the Action KB module to obtain the actions list currently available to the electronic device system;

(a3) Calling an AI model (such as a large language model or other target model) to predict possible user actions based on the current screen content and the actions list currently available to the electronic device system, obtaining one or more target actions that correspond to the intention represented by the screen interface content;

(a4) Presenting the prediction result to the user.

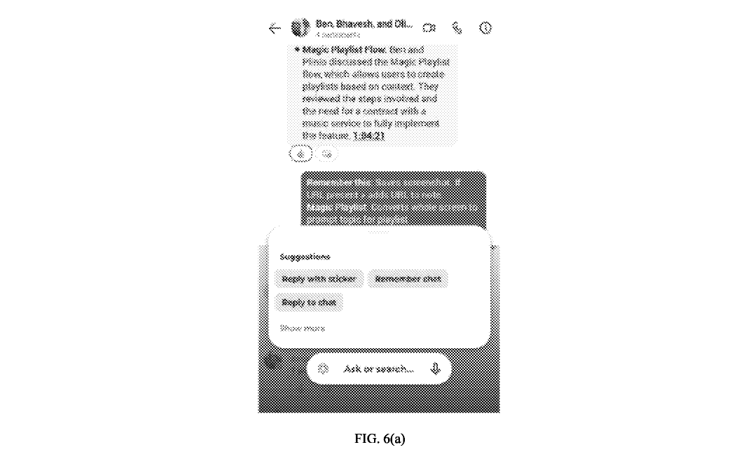

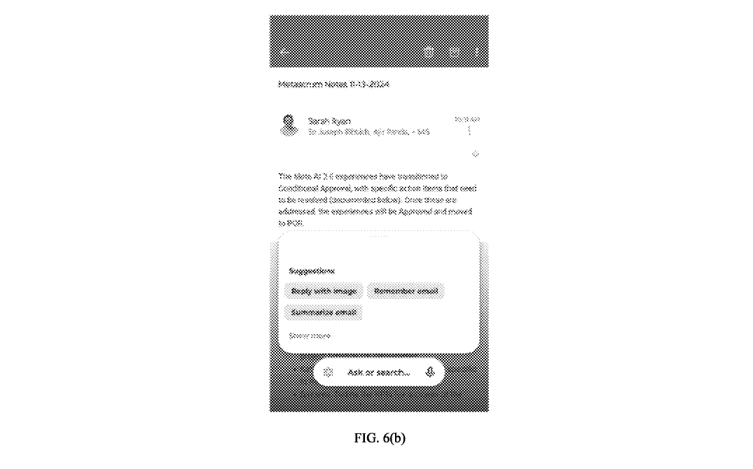

See FIGS. 6(a) and 6(b). FIG. 6(a) is a schematic diagram illustrating how the system extracts screen content from the user's instant messaging interface, and then uses a large language model based on this screen content and actions list to predict and display various target actions that correspond to the content of the instant messaging interface. In particular, the target actions that correspond to the instant messaging interface content are the actions included in "suggestions" in FIG. 6(a); FIG. 6(b) shows a schematic diagram illustrating how, by extracting screen content from the user's email application interface, a large language model is then used to predict and display various target actions that correspond to the current email application interface, based on the extracted screen content and a list of possible actions. Similarly, the target actions aligning with the email application interface in FIG. 6(b) are the actions included in the "suggestions" section.

Users may trigger the execution of a target action by selecting it, such as clicking "summarize email" in the suggestions shown in FIG. 6(b) to summarize the current email content.

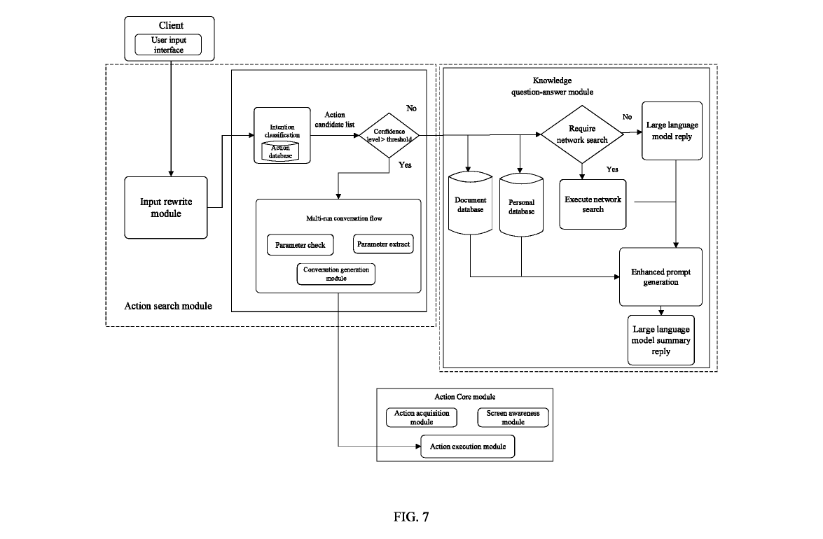

See FIG. 7 for the flowchart of the second mode's function execution process. The exemplary implementation process of the second mode's function, "Find, do, ask anything," includes:

(b1) Obtaining user input data, such as commands entered by the user through the Moto AI interactive interface.

(b2) Rewriting the user input data, including but not limited to language checking, proper noun replacement, and translation.

(b3) The intention recognition module calls the Action KB module to convert the rewritten user input data into a vector, and measure the similarity (vector distance) between this vector and the vectors of various actions stored in the actions database. Finally, it selects the k Action vectors closest to the user input data vector, and obtains the similarity scores and corresponding Actions for these k Action vectors.

(b4) When there is an Action vector among the k Action vectors with a corresponding similarity score exceeding a threshold (for example, 0.8), the user input data is considered a highly credible Action execution command. In this scenario, this step may continue by using a large language model for decision-making. The user's input data and the Action attributes corresponding to the k Action vectors returned in step (b3) (such as name, description, examples, or the like) are output to the large language model or other target models. The model then decides whether each Action corresponds to the user's input, thus further determining whether the user input data is a credible Action execution command.

(b5) If the executed command corresponds to a trustworthy action, it is determined that the user intends to perform that action. In this case, the action is checked against the required execution parameters of the matched action (for example, the target action with the highest confidence score). If any required parameters are missing, the system interacts with the user through a conversational interface to obtain the necessary parameters. Finally, the action is executed based on the provided parameters.

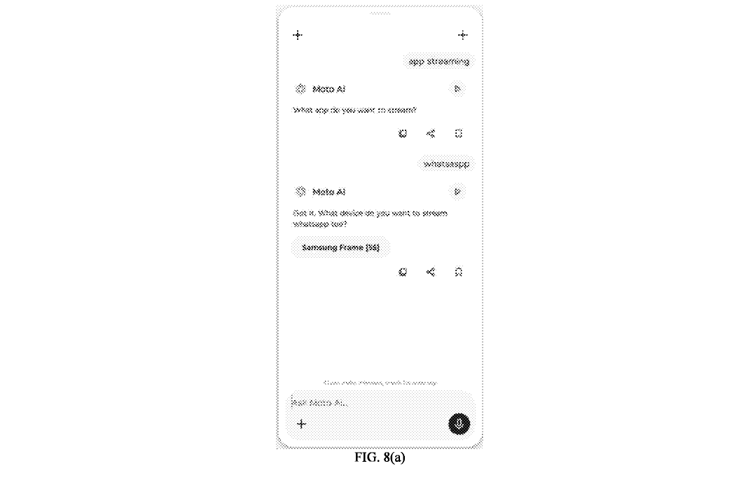

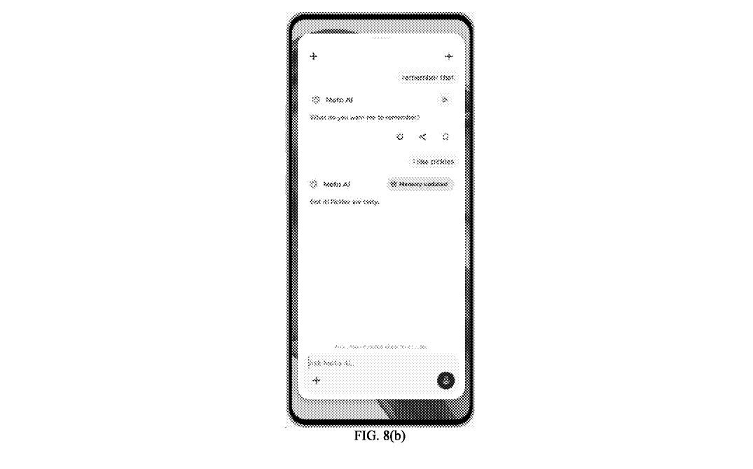

See FIGS. 8(a) and 8(b), which respectively show example diagrams illustrating how the execution parameters for two target actions—screen projecting and information recording—are identified through conversation interaction with the user on Moto AI.

(b6) When the command is deemed not to be a credible action execution command, it is considered a user query. In this scenario, a large language model or other target model may be used to generate corresponding answer information based on the user's input data.

When generating answer information for user input data, the system may first generate corresponding candidate answer information through various methods such as GKB (General Knowledge Base) search, PKB (Personal Knowledge Base) search, web search, and large language model responses; based on this, the user input data and the candidate answer information obtained through the above methods may be input into a large language model, which then summarizes and generates the final answer information.

The GKB (General Knowledge Base) may include knowledge information that users search for and store from the internet, while the PKB (Personal Knowledge Base) may include users' personal knowledge data, such as their preferences in various aspects.

In certain embodiments, a knowledge question-answer module may be set up within an intelligence processing module, such as an AI processing module, to be responsible for generating corresponding answer information for the user's input data.

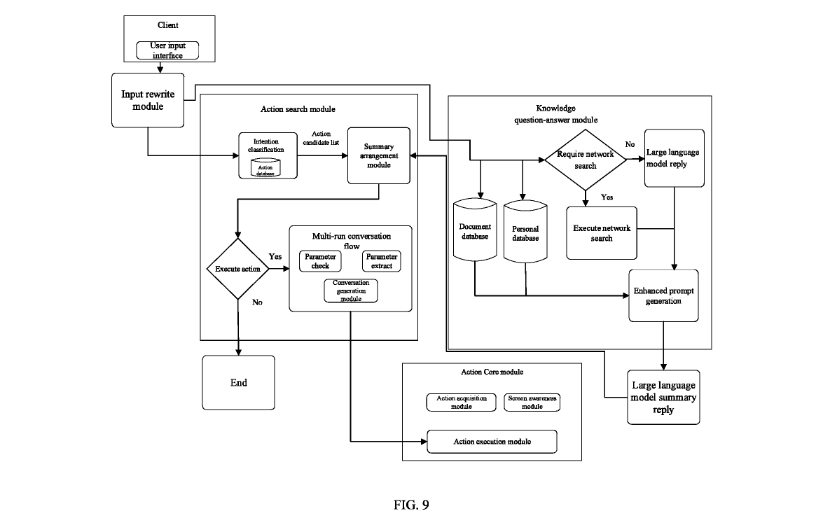

The implementation process described above for the second mode may also be replaced with another implementation method, as shown in the function execution flowchart of the second mode in FIG. 9. In this implementation method, when performing step (b3), the following process is also executed (steps b4-b6 are skipped and not executed):

(b7) The user input data is simultaneously treated as a query question, so that the answer generation process for the user input data is also performed synchronously when executing step (b3).

The process of generating answers based on user input data is described at step (b6) and is not detailed further here.

(b8) The k actions returned at step (b3) and the answer information returned at step (b7) are summarized and presented to the user. See the example in FIG. 4 above for details. This implementation simultaneously outputs descriptions of target actions aligning with the input data and corresponding responses.

Through these two modes, this example demonstrates how AI may provide users with intelligence services in real time and efficiently, assisting them in quickly using relevant applications.

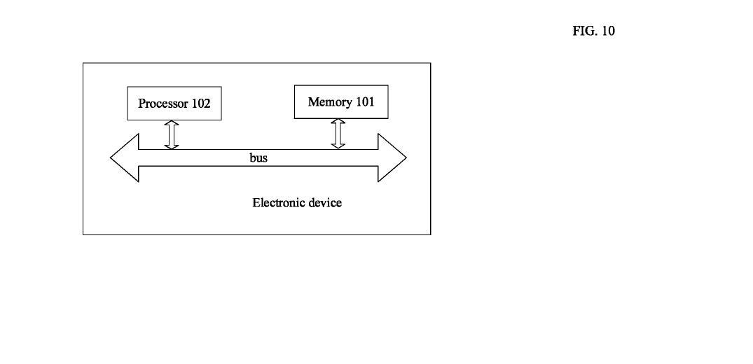

The present disclosure in certain embodiments also discloses an electronic device, the structure of which is shown in FIG. 10, and which includes at least:

a memory 101, configured to store a set of computer instructions;

the set of computer instructions may be implemented in the form of a computer program;

a processor 102, configured to implement the processing method provided in any of the method embodiments described above by executing the set of computer instructions in the memory.

Processor 102 may be a central processing unit (CPU), application-specific integrated circuit (ASIC), digital signal processor (DSP), field-programmable gate array (FPGA), neural network processor (NPU), deep learning processor (DPU), or other programmable logic devices.

In certain embodiments, the electronic device may also include storage resources such as memory and cache.

In certain embodiments, the electronic device may include a camera component and/or be connected to an external camera component.

In certain embodiments, the electronic device may include parts such as a communication interface and a communication bus. The memory, processor, and communication interface communicate with each other via the communication bus.

Communication interfaces are used for communication between electronic devices and other devices. The communication bus may be a Peripheral Component Interconnect (PCI) bus or an Extended Industry Standard Architecture (EISA) bus, or the like., and this communication bus may be divided into an address bus, a data bus, and a control bus.

The present disclosure in certain embodiments discloses a storage medium, which carries one or more sets of computer instructions. When executed by an electronic device, these one or more sets of computer instructions enable the electronic device to implement the processing method described in any of the method embodiments above.

Certain embodiments are described herein, with each embodiment focusing on the differences from other embodiments. Reference may be made to similar or identical parts between certain embodiments.

For convenience of description, the above systems or devices are described by dividing them into various modules or units based on their functions. When implementing the present disclosure, the functions of each unit may be implemented in one or more software and/or hardware components.

From the above description of the implementation methods, those skilled in the technical field may understand that the present disclosure may be implemented by software combined with the suitable general-purpose hardware platform. Based on this understanding, the technical solution of the present disclosure, or more precisely, the part that makes a creative contribution, may be embodied in the form of a software product. This computer software product may be stored on a storage medium, such as ROM/RAM, magnetic disk, or optical disc, and includes a number of instructions that enable a computer device (which may be a personal computer, server, or network device, or the like to execute the methods described in the various embodiments or part of certain embodiments of the present disclosure.

Relational terms such as first, second, third, and fourth are used to distinguish one entity or operation from another, and do not necessarily require or imply any actual relationship or sequence between these entities or operations. Furthermore, the terms "including," "comprising," or any other variations thereof are intended to cover non-exclusive inclusion, so that a process, method, device, or apparatus that includes a series of elements includes not only those elements but also other elements not explicitly listed, or elements inherent to such a process, method, article, or apparatus. Unless otherwise limited, an element defined by the phrase "including a..." or "comprising a…" does not necessarily exclude the presence of other identical elements in the process, method, device, or apparatus that includes the element.

The above description represents certain embodiments of the present disclosure. For those skilled in the technical field, modifications and variations may be made without departing from the principles of the present disclosure, and these modifications and variations may be considered within the scope of protection of the present disclosure.

What is claimed is:

1. A processing apparatus, comprising:
an action processing module, configured to obtain an action set formed by function units of at least one application on an electronic device, the action set representing actions that the electronic device is able to perform; and
an intelligence processing module, configured to determine, in response to input data, a target action from the action set that corresponds to an intention represented by the input data through a target model, the intention being related to the target action.

2. The processing apparatus of claim 1, wherein the action processing module is further configured to:
update the action set in response to an update of the at least one application on the electronic device and/or an update of the function units of the at least one application.

3. The processing apparatus of claim 1, wherein the intelligence processing module is further configured to:
obtain the input data.

4. The processing apparatus of claim 3, wherein the intelligence processing module is further configured to:
process the input data to determine the intention represented by the input data;
in response to the intention represented by the input data including a target intention, trigger the process of determining the target action from the action set that corresponds to the intention represented by the input data using the target model, wherein the target intention is related to the target action; and
in response to the intention represented by the input data not including the target intention, generate answer information corresponding to the intention represented by the input data using the target model.

5. The processing apparatus of claim 4, wherein the intelligence processing module is further configured to:
detect whether execution parameters required to perform the target action are currently missing;
if so, identify the execution parameters required to perform the target action through one or more conversation interactions with a user; and
the action processing module is further configured to: perform the target action based on the execution parameters required to perform the target action.

6. A processing method, comprising:
obtaining input data;
obtaining an action set based on the input data, the action set representing actions that an electronic device is able to perform;
determining a target action based on the input data, the action set, and a target model; and
outputting a response content to the input data, wherein the response content is related to the target action.

7. The processing method of claim 6, wherein outputting the response content includes one or more of:
executing the target action while simultaneously outputting the response content;
obtaining interactive controls based on the target action, and outputting the response content based on the interactive controls, wherein the response content includes the interactive controls of the target action; and
outputting a description of the target action, and outputting the response content along with the description of the target action.

8. The processing method of claim 6, wherein the target action corresponds to the intention represented by the input data.

9. The processing method of claim 6, wherein the target action includes at least one executable action, and the at least one executable action is a next action that the electronic device is able to perform in response to the input data.

10. The processing method of claim 6, wherein obtaining the input data includes one or more of:
obtaining interaction information input through an interaction interface of the electronic device;
obtaining interface information obtained by performing information recognition and extraction on the screen interface of the electronic device; and
obtaining image information captured by an image acquisition apparatus.

11. The processing method of claim 6, further comprising:
processing the input data to determine the intention represented by the input data;
in response to the intention represented by the input data including a target intention, triggering a process to determine a target action based on the input data, the action set, and the target model; the target intention is related to the target action;
in response to the intention represented by the input data not including the target intention, generating answer information corresponding to the intention represented by the input data through the target model.

12. The processing method of claim 6, further comprising:
executing the target action based on the execution parameters required to perform the target action.

13. The processing method of claim 12, further comprising:
detecting whether the execution parameters required for performing the target action are currently missing;
if so, identifying the execution parameters required for performing the target action through one or more conversation interactions with a user.

14. An electronic device, comprising: a memory storing computer program instructions; and a processor coupled to the memory and configured to execute the computer program instructions and perform:
obtaining input data;
obtaining an action set based on the input data, the action set representing actions that the electronic device is able to perform;
determining a target action based on the action set and a target model; and
outputting a response content to the input data, wherein the response content is related to the target action.

15. The electronic device of claim 14, wherein outputting the response content includes one or more of:
executing the target action while simultaneously outputting the response content;
obtaining interactive controls based on the target action and outputting the response content based on the interactive controls; and
outputting a description of the target action, and outputting the response content along with the description of the target action.

16. The electronic device of claim 14, wherein the target action corresponds to the intention represented by the input data.

17. The electronic device of claim 14, wherein the target action includes at least one executable action, and the at least one executable action is a next action that the electronic device is able to perform in response to the input data.

18. The electronic device of claim 14, wherein obtaining the input data includes one or more of:
obtaining interaction information input through an interaction interface of the electronic device;
obtaining interface information obtained by performing information recognition and extraction on the screen interface of the electronic device; and
obtaining image information captured by an image acquisition apparatus.

19. The electronic device of claim 14, wherein the processor is further configured to perform:
processing the input data to determine the intention represented by the input data;
in response to the intention represented by the input data including a target intention, triggering a process to determine a target action based on the input data, the action set, and the target model; the target intention is related to the target action;
in response to the intention represented by the input data not including the target intention, generating answer information corresponding to the intention represented by the input data through the target model.

20. The electronic device of claim 14, wherein the processor is further configured to perform:
executing the target action based on execution parameters required to perform the target action.
